(19) United States
(12) Patent Application Publication
(10) Pub. No.: US 2015/0350899 A1
(43) Pub. Date: Dec. 3, 2015

(54) AUTHENTICATION METHOD OF VoLTE

(71) Applicant: National Taipei University of Technology, Taipei City (TW)

(72) Inventors: Shaw Hwa HWANG, Taipei City (TW); Cheng Yu YEH, Taipei City (TW); Kuan Lin CHEN, Taipei City (TW); Yao Hsing CHUNG, Taipei City (TW); Chi Jung HUANG, Taipei City (TW); Li Te SHEN, Taipei City (TW); Shun Chieh CHANG, Taipei City (TW); Ming Che YEH, Taipei City (TW); Bing Chih YAO, Taipei City (TW); Chao Ping CHU, Taipei City (TW); Ning Yun KU, Taipei City (TW); Tzu Hung LIN, Taipei City (TW)

(21) Appl. No.: 14/308,068

(22) Filed: Jun. 18, 2014

(30) Foreign Application Priority Data
May 28, 2014 (TW) 103118506

(51) Int. Cl. H04W 12/06; H04L 29/06

(52) U.S. Cl. CPC H04W 12/06; H04L 63/0853; H04L 63/0876

(57) ABSTRACT

The present invention provides VoIP authentication in 4G VoLTE, and also provides an extra authentication method of VoLTE for achieving communication security. The key point of the extra authentication method of VoLTE is: when a 4G mobile phone is turned on for the first time, a security registration sequence number will be random generated by the 4G mobile phone, and sent with IMSI and IMEI through TLS to an account assignment server for comparison and storage. Thereafter the account assignment server sends an account and a password in a database corresponding to IMSI to the 4G mobile phone, and then the 4G mobile phone conducts VoIP authentication with a SIP server for standby or communication.

### FIELD OF THE INVENTION

The present invention relates to an authentication method of VoLTE in 4G, and more particularly to a method of providing a security registration sequence number for achieving authentication.

### BACKGROUND OF THE INVENTION

Mobile phone communication has entered from 3G into 4G VoLTE (Voice over Long Term Evolution), but up to the present a 4G Mobile phone adopts Packet Switching for getting on the Internet instead of Circuit Switching, an account number and a password have to be inputted during dialing, this is very inconvenient to the user. Therefore presently when a 4G Mobile phone dials a call, actually it falls back to Circuit Switching in 3G mode.

Firstly the method of 3G mobile phone communication is described. A SIM (Subscriber identity Module) card is allocated to each 3G mobile phone. A SIM card is a smart card for securely stores the International Mobile Subscriber Identity (IMSI) for a mobile phone. When a 3G mobile phone is turned on, an AKA (Authentication and Key Agreement) mechanism will be used for authenticating IMSI with a server. If the authentication is confirmed, the 3G mobile phone is standby for communication.

A 3G mobile phone adopts Circuit Switching for dialing, as shown in FIG. 1, mobile phone 1 goes through base station 2, ChungHwa Telecommunication PSTN (Public Switched Telephone Network) 3 for communication with telephone 4. This is a dedicated circuit without any confidential problem.

Referring to FIG. 2, the 4G mobile phone communication is schematically shown. Mobile phone 5, mobile phone 6, PC 7, PC 8 goes through base station 9, base station 10 respectively for connecting with Internet 11 for communication. Packet Switching is adopted for speed-up and saving bandwidth, but confidential problem will be incurred.

Referring to FIG. 3, VoIP (Voice over Internat Protocol) is described. VoIP is based on SIP (Session Initiation Protocol). PC 12 has an account number and a password, while SIP server 13 also stores the account number and the password of the PC 12. When PC 12 wants to conduct Internet phone communication, a REGISTER instruction will be used for sending the account number thereof to SIP server 13. SIP Server 13 uses the account number to find a corresponding password, and generate a random number “nonce”, then uses MD5 (Message-Digest Algorithm 5) to calculate a result “Response” based on the password and the random number “nonce”. SIP server 13 uses 401 Unauthorized (nonce, MD5) instruction for sending the “nonce” and MD5 to PC 12. PC 12 uses the password thereof and the “nonce” to calculate a result “Response” by MD5, then uses REGISTER instruction for sending the “Response” to the SIP server 13. The SIP server 13 compares “Response” with “Response”, if both are equal, then authentication is confirmed, the SIP server 13 sends 200 OK instruction to PC 12, both sides can communicate with each other, otherwise the communication cannot be conducted,

MD5 (Message-Digest Algorithm 5) is a widely used cryptographic hash function producing a 128-bit (16-byte) hash value, typically expressed in text format as a 32 digit hexadecimal number. MD5 has been utilized in a wide variety of cryptographic applications, and is also commonly used to verify data integrity.

The above-mentioned VoIP authentication is conducted in packet forms on the Internet publicly, confidential problem will be incurred. The SIM card allocated for 3G mobile phone can be easily pirated in 4G VoLTE.

### SUMMARY OF THE INVENTION

The object of the present invention is to provide VoIP authentication in 4G VoLTE for Internet communication, and also provide an extra authentication method in 4G VoLTE for achieving communication security.

The authentication method of VoLTE according to the present invention is stated as follows: in a 4G mobile phone communication system, comprising: a 4G mobile phone, a SIM card, an account assignment server, a database, and a SIP server.

When the 4G mobile phone is turned on for the first time, a TLS connection is established between the 4G mobile phone and the account assignment server, the 4G mobile phone sends an IMSI of the SIM card and a random generated “security registration sequence number” to the account assignment server, then the account assignment server checks if the IMSI of the SIM card is equal to an IMSI stored in the database; if both are equal, then the “security registration sequence number” is stored in the database.

Thereafter the account assignment server sends an account number and a password in the database corresponding to the IMSI of the SIM card to the 4G mobile phone; after the 4G mobile phone receives the corresponding account number and password, closes the TLS connection, and then perform an authentication with the SIP server according to VoIP authentication procedures; If the authentication is confirmed, the 4G mobile phone is standby for communication.

In the above-mentioned that when the TLS connection is established between the 4G mobile phone and the account assignment server, the 4G mobile phone sends an IMSI of the SIM card, an IMEI of the 4G mobile phone and a random generated “security registration sequence number” to the account assignment server, then the account assignment server checks if the IMSI of the SIM card is equal to an IMSI stored in the database; if both are equal, then the IMEI of the 4G mobile phone and the “security registration sequence number” are stored in the database.

When the 4G mobile phone is standby or in communication, a REGISTER instruction including the “security registration sequence number” of the 4G mobile phone and a regular interval is sent by the 4G mobile phone at the regular interval continuously to the SIP server, the “security registration sequence number” of the 4G mobile phone performs an increment or decrement for each regular interval, and the “security registration sequence number” stored in the database also performs a same increment or decrement for each regular interval; the SIP server checks if the “security registration sequence number” of the 4G mobile phone is equal to the “security registration sequence number” stored in the database, if both are equal, then the SIP server sends a 200 OK instruction to the 4G mobile phone; the processes are repeated when the 4G mobile phone is standby or in communication, so as to achieve confidential security.

After the 4G mobile phone is turned off and then turned on again, the 4G mobile phone sends the IMSI of the SIM card, the IMEI of the 4G mobile phone and the random generated “security registration sequence number” to the account assignment server, then the account assignment server checks if the IMSI of the SIM card, the IMEI of the 4G mobile phone and the random generated “security registration sequence number” are equal to an IMSI, IMEI and a “security registration sequence number” stored in the database; if all are equal, then the account assignment server sends a corresponding account number and a password stored in the database to the 4G mobile phone for performing the authentication with the SIP server according to VoIP authentication procedures; If the authentication is confirmed, the 4G mobile phone is standby for communication.

If no any IMSI stored in the database meets the IMSI of the SIM card, then the account assignment server sends an instruction to the 4G mobile phone to report, that no such user, registration cannot be achieved.

If an IMSI in the database meets the IMSI of the SIM card, but the corresponding IMEI or “security registration sequence number” stored in the database does not meet the MEI or the “security registration sequence number” of the 4G mobile phone, then the account assignment server sends an instruction to the 4G mobile phone to lock the 4G mobile phone, and the 4G mobile phone is prohibited from registration to avoid pirating.

After the 4G mobile phone is turned off, the stored account number and password in the 4G mobile phone disappear; while the “security registration sequence number” is stored in the 4G mobile phone and the database.

### BRIEF DESCRIPTION OF THE DRAWINGS

FIG. 1 shows schematically 3G mobile phone communication.

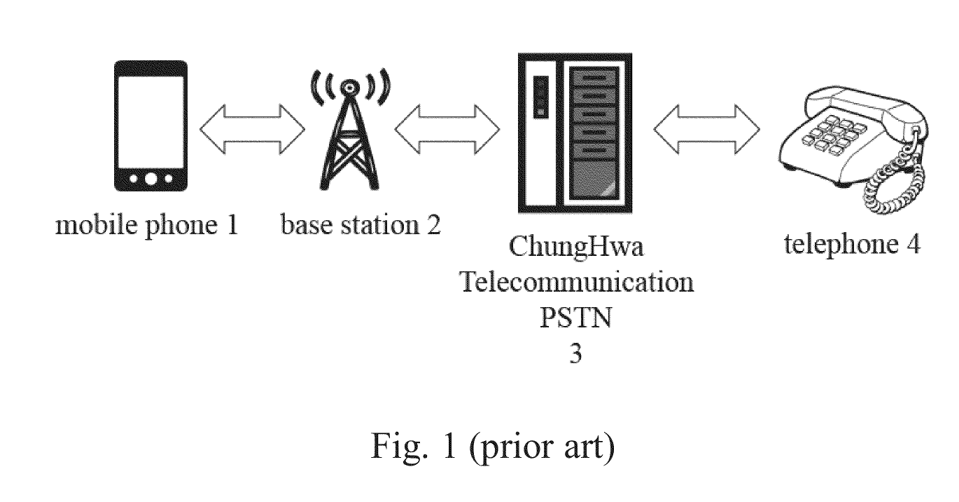

FIG. 2 shows schematically 4G mobile phone communication.

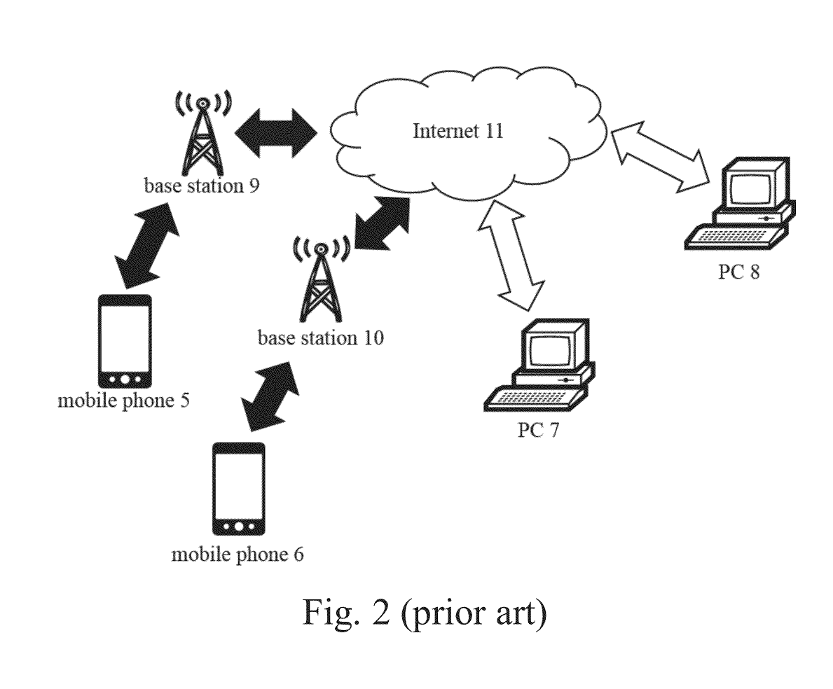

FIG. 3 shows schematically VoIP communication.

FIG. 4 shows schematically the authentication procedures in 4G VoLTE according to the present invention.

FIG. 5 shows schematically a TLS connection for 4G mobile phone in detail.

FIG. 6 shows schematically a TLS connection after 4G mobile phone is turned off and then turned on again.

FIG. 7 shows schematically that IMSI′ of the SIM card does not meet any IMSI in the account assignment server.

FIG. 8 shows schematically that IMEI′ or CSeq′ of the 4G mobile phone does not meet IMEI or CSeq in the account assignment server.

FIG. 9 shows schematically the increment or decrement of the security registration sequence number CSeq.

### DETAILED DESCRIPTIONS OF THE PREFERRED EMBODIMENTS

The present invention provides VoIP authentication in 4G VoLTE for Internet communication, and also provides an extra authentication method in 4G VoLTE for achieving communication security.

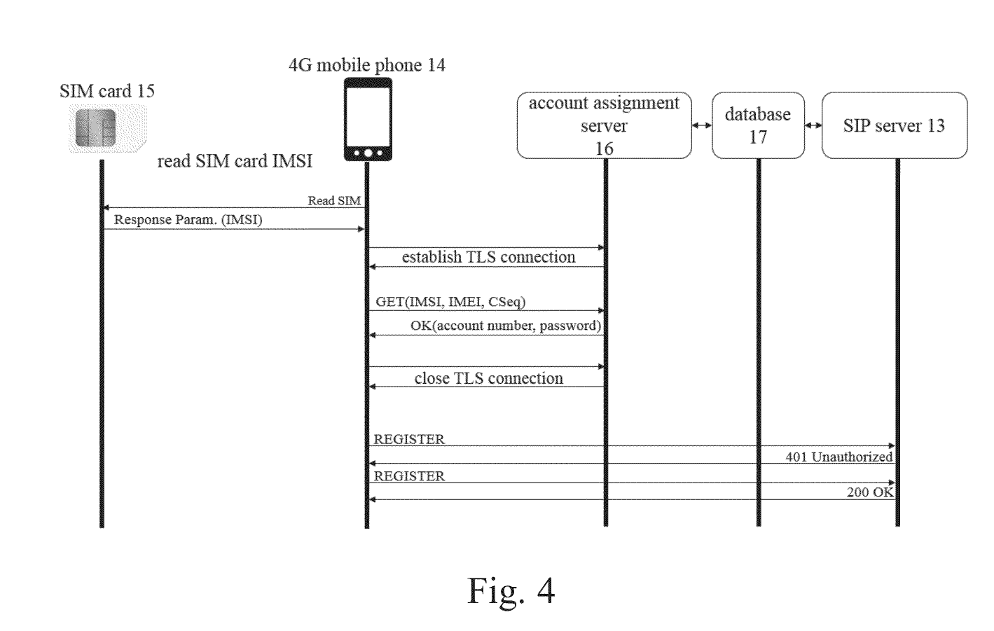

Referring to FIG. 4, the authentication procedures in 4G VoLTE according to the present invention is described. In FIG. 4, when a 4G mobile phone 14 is turned on for the first time, a Read SIM instruction is used to inquire an IMSI (International Mobile Subscriber Identity) of an SIM card 15 thereof, then the SIM card 15 uses Response Parameter (IMSI) for sending the IMSI of the SIM card 15 to the 4G mobile phone 14.

Thereafter the present invention uses TLS (Transport Layer Security) for connecting the 4G mobile phone 14 and an account assignment server 16. TLS uses cryptographic algorithm for providing identity authentication and communication security in Internet, based on public key infrastructure (PKI).

In FIG. 4, a TLS connection is established between the 4G mobile phone 14 and the account assignment server 16. The 4G mobile phone 14 sends IMSI of the SIM card 15, IMEI (International Mobile Equipment Identity number) of the 4G mobile phone 14, and a random generated “security registration sequence number” CSeq by GET instruction to the account assignment server 16 for storing in a database 17. Then the account assignment server 16 sends a set of corresponding account number and password (settled when purchasing the 4G mobile phone 14) by OK instruction to the 4G mobile phone 14.

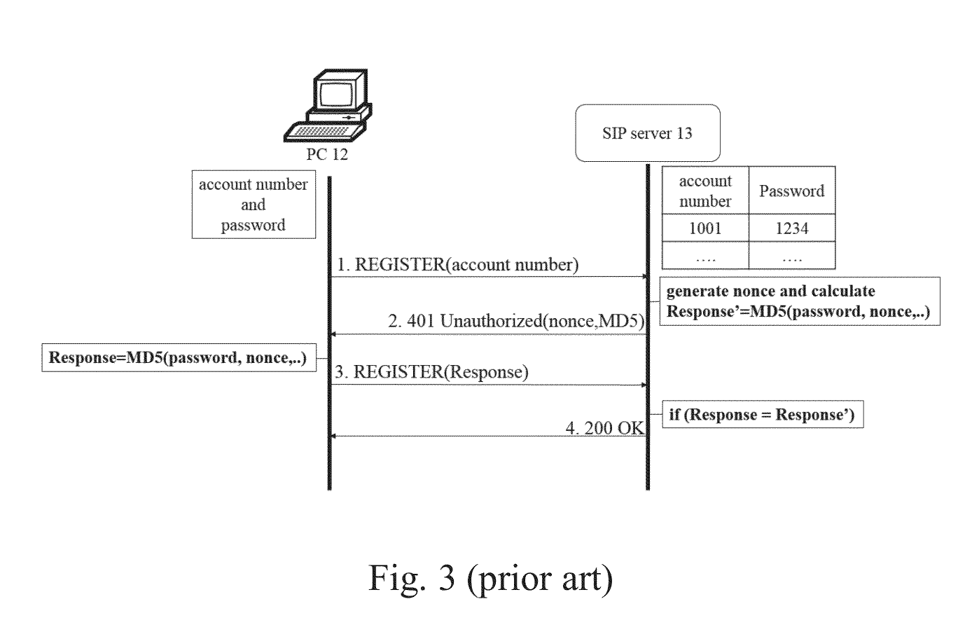

After the 4G mobile phone 14 receives the set of corresponding account number and password, closes the TLS connection, and then uses REGISTER instruction to perform authentication with SIP server 13 according to the VoIP authentication procedures in FIG. 3. If the authentication is confirmed, the 4G mobile phone 14 is standby for communication.

After the 4G mobile phone 14 is turned off, the stored account number and password in the 4G mobile phone 14 will disappear to avoid divulging. A user does not have to remember the account number and the password. Thereafter each time the 4G mobile phone 14 is turned on again, the user does not have to input the account number and the password, the account number and the password will be sent by the account assignment server 16 through OK instruction to the 4G mobile phone 14, the 4G mobile phone 14 uses REGISTER instruction to perform authentication with SIP server 13 according to the VoIP authentication procedures in FIG. 3. If the authentication is confirmed, the 4G mobile phone 14 is standby for communication.

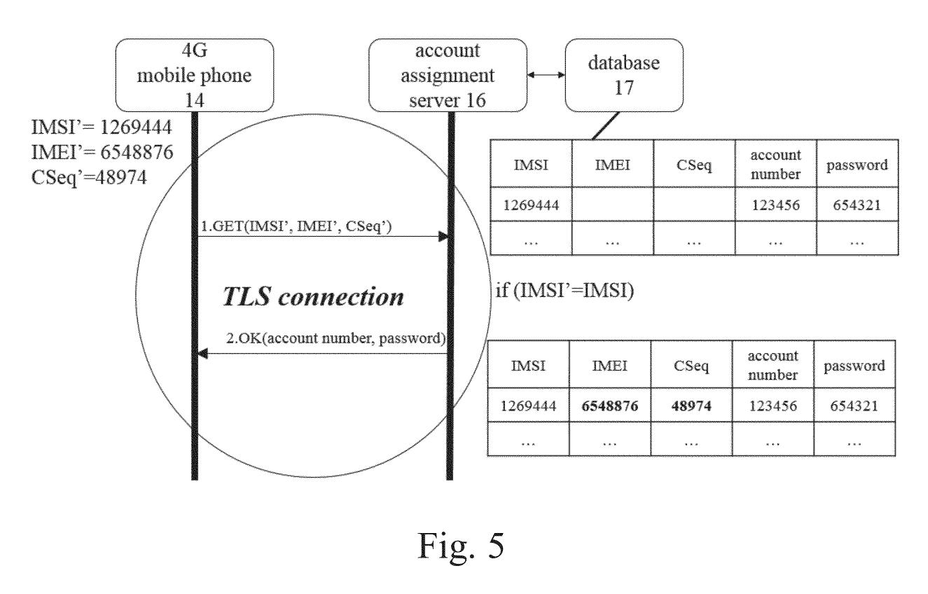

The TLS connection is described in detail as follows, Referring to FIG. 5, IMSI′ of the SIM card 15 is 1269444, IMEI′ of the 4G mobile phone 14 is 6548876, a random generated “security registration sequence number” CSeq′ is 48974. The 4G mobile phone 14 sends the three numbers to the account assignment server 16 by GET instruction. The database 17 had stored IMSI 1269444, account number 123456 and password 654321 (settled when purchasing the 4G mobile phone 14). The account assignment server 16 checks if is equal to IMSI′ if both are equal, then fill IMEI′ 6548876, CSeq′ 48974 into IMEI, CSeq of the database 17, and then the account number 123456 and the password 654321 in the database 17 is sent by OK instruction to the 4G mobile phone 14, the 4G mobile phone 14 uses REGISTER instruction to perform authentication with SIP server 13 according to the VoIP authentication procedures in FIG. 3. If the authentication is confirmed, the 4G mobile phone 14 is standby for communication.

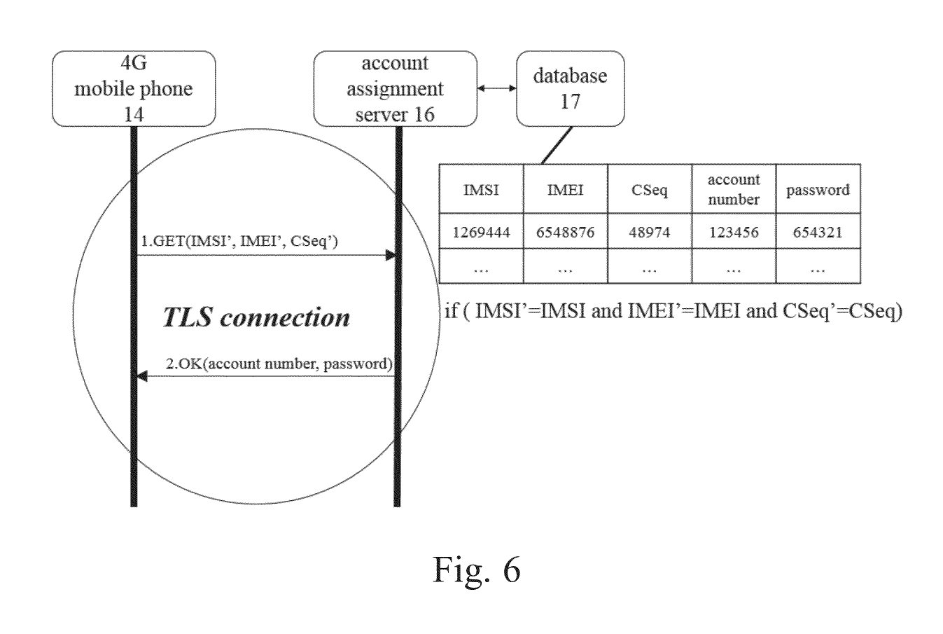

Referring to FIG. 6, after the 4G mobile phone 14 is turned off and then turned on again, the 4G mobile phone 14 sends IMSI′ 1269444, IMEI′ 6548876, CSeq′ 48974 by GET instruction to the account assignment server 16. The account assignment server 16 compare IMSI′ 1269444, IMEI′ 6548876, CSeq′ 48974 with IMSI, IMEI, CSeq in database 17 to see if all are matched. If all are matched, then the account assignment server 16 sends the corresponding account number and password in database 17 to the 4G mobile phone 14 by OK instruction, the 4G mobile phone 14 uses REGISTER instruction to perform authentication with SIP server 13 according to the VoIP authentication procedures in FIG. 3. If the authentication is confirmed, the 4G mobile phone 14 is standby for communication.

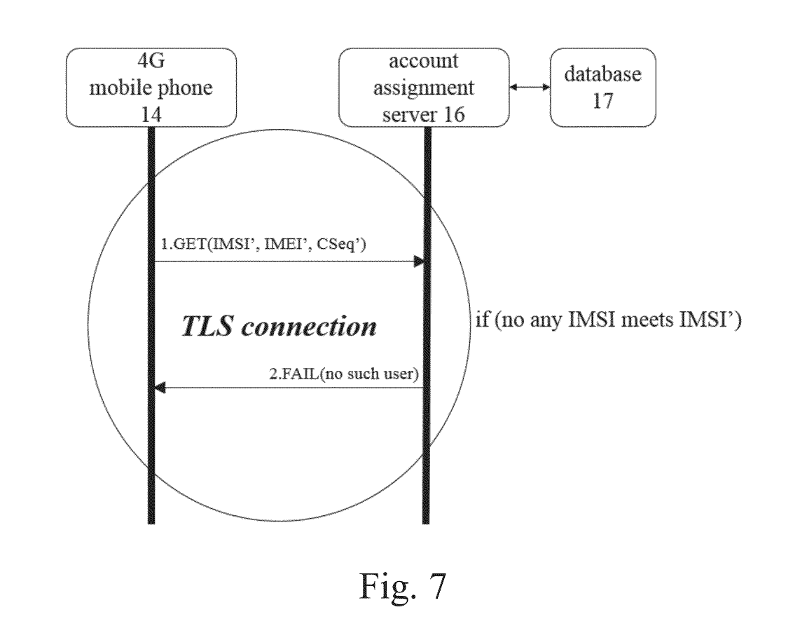

If no any IMSI meets the IMSI′ then the account assignment server 16 sends FAIL instruction to the 4G mobile phone 14 to report that no such user, registration cannot. be achieved, as shown in FIG. 7.

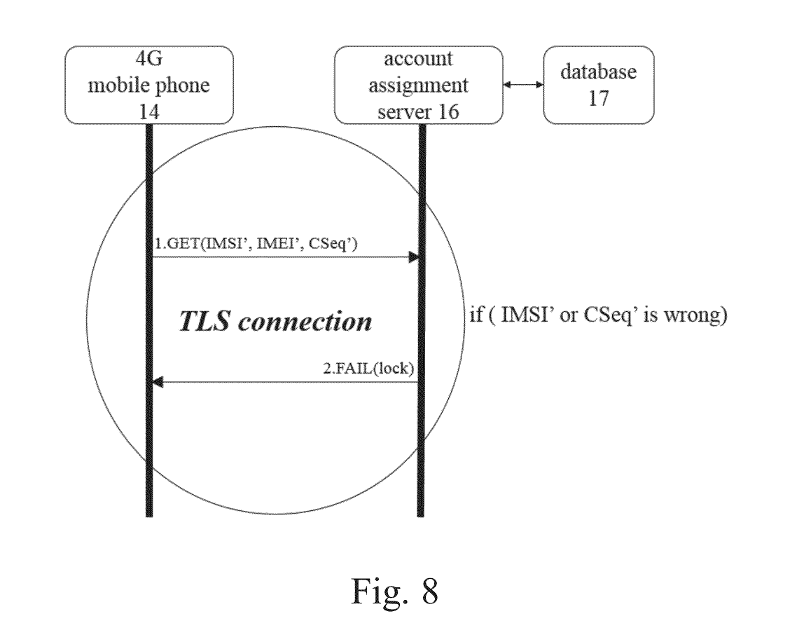

If an IMSI meets the IMSI′, while IMEI′ is not equal to IMEI or CSeq′ is not equal to CSeq, then the account assignment server 16 sends FAIL instruction to the 4G mobile phone 14 to lock the 4G mobile phone 14, and the 4G mobile phone 14 is prohibited from registration to avoid pirating, as shown in FIG. 8.

The first random generated “security registration sequence number” CSeq is stored in the 4G mobile phone 14 and the database 17. Each time the 4G mobile phone 14 is turned on, the CSeq in the 4G mobile phone 14 and the CSeq in the database 17 are checked to see if both are matched, this is the key point of the present invention.

When a 4G mobile phone 14 is turned on for the first time, a random generated “security registration sequence number” CSeq is sent by GET instruction to the account assignment server 16 for storing in a database 17. Before the 4G mobile phone 14 is turned off, the 4G mobile phone 14 continues to perform increment or decrement of CSeq.

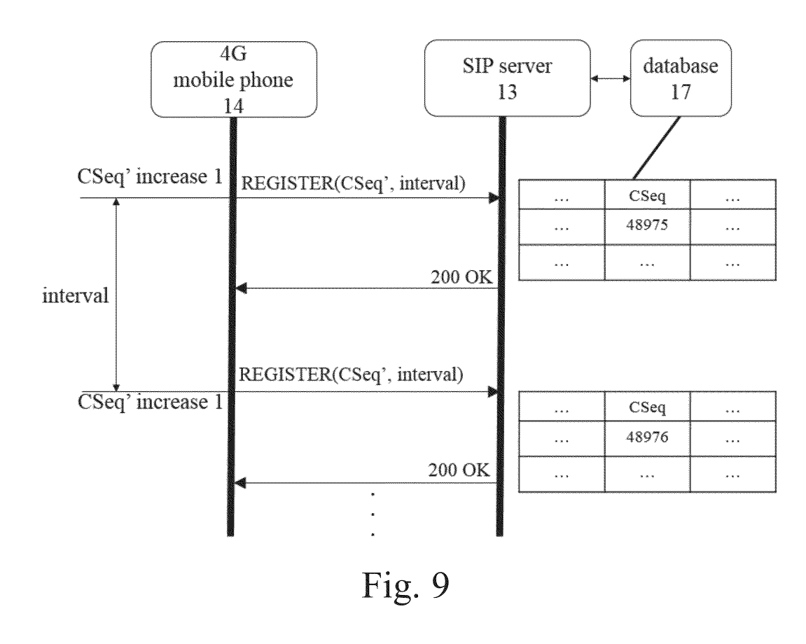

Referring to FIG. 9, the increment or decrement of CSeq is further described. When the 4G mobile phone 14 is standby or in communication, a REGISTER instruction will be sent by the 4G mobile phone 14 at regular intervals (e.g. 20 seconds) to the SIP server 13. The REGISTER instruction includes CSeq′ and the regular interval, CSeq′ will increase 1 (increase 2, 3 or decrease 1 . . . are also OK, and is settled when the 4G mobile phone 14 is produced) compared with the last CSeq′ 48974, and becomes 48975. The CSeq in the database 17 will also increase 1 (increase 2, 3 or decrease 1 . . . are also OK, and is settled when the 4G mobile phone 14 is sold) according to the regular interval (e.g. 20 seconds) to become 48975. The SIP server 13 checks if CSeq′ is equal to CSeq, if both are equal, then the SIP server 13 sends 200 OK instruction to the 4G mobile phone 14. After a regular interval (e.g. 20 seconds), both CSeq′ and CSeq will increase 1 again to become 48976. The 4G mobile phone 14 sends REGISTER instruction including CSeq′ and the regular interval to the SIP server 13. The SIP server 13 checks if CSeq′ is equal to CSeq, if both are equal, then the SIP server 13 sends 200 OK instruction to the 4G mobile phone 14. The processes are repeated when the 4G mobile phone 14 is standby or in communication, so as to achieve confidential security.

The scope of the present invention depends upon the following claims, and is not limited by the above embodiments.

What is claimed is:

1. An authentication method of VoLTE, in a 4G mobile phone communication system, comprising:
a 4G mobile phone;
a SIM card;
an account assignment server;
a database;
a SIP server;
wherein when the 4G mobile phone is turned on for the first time, a TLS connection is established between the 4G mobile phone and the account assignment server; the 4G mobile phone sends an IMSI of the SIM card and a random generated “security registration sequence number” to the account assignment server, then the account assignment server checks if the IMSI of the SIM card is equal to an IMSI stored in the database; if both are equal, then the “security registration sequence number” is stored in the database;
thereafter the account assignment server sends an account number and a password in the database corresponding to the IMSI of the SIM card to the 4G mobile phone;
after the 4G mobile phone receives the corresponding account number and password, closes the TLS connection, and then perform an authentication with the SIP server according to VoIP authentication procedures; If the authentication is confirmed, the 4G mobile phone is standby for communication.

2. The authentication method of VoLTE according to claim 1, wherein when the TLS connection is established between the 4G mobile phone and the account assignment server; the 4G mobile phone sends an IMSI of the SIM card, an IMEI of the 4G mobile phone and a random generated “security registration sequence number” to the account assignment server, then the account assignment server checks if the IMSI of the SIM card is equal to an IMSI stored in the database; if both are equal, then the IMEI of the 4G mobile phone and the “security registration sequence number” are stored in the database.

3. The authentication method of VoLTE according to claim 1, wherein when the 4G mobile phone is standby or in communication, a REGISTER instruction including the “security registration sequence number” of the 4G mobile phone and a regular interval is sent by the 4G mobile phone at the regular interval continuously to the SIP server, the “security registration sequence number” of the 4G mobile phone performs an increment or decrement for each regular interval, and the “security registration sequence number” stored in the database also performs a same increment or decrement for each regular interval; the SIP server checks if the “security registration sequence number” of the 4G mobile phone is equal to the “security registration sequence number” stored in the database, if both are equal, then the SIP server sends a 200 OK instruction to the 4G mobile phone; the processes are repeated when the 4G mobile phone is standby or in communication, so as to achieve confidential security.

4. The authentication method of VoLTE according to claim 2, wherein after the 4G mobile phone is turned off and then turned on again, the 4G mobile phone sends the IMSI of the SIM card, the IMEI of the 4G mobile phone and the random generated “security registration sequence number” to the account assignment server, then the account assignment server checks if the IMSI of the SIM card, the IMEI of the 4G mobile phone and the random generated “security registration sequence number” are equal to an IMSI, an IMEI and a “security registration sequence number” stored in the database if all are equal, then the account assignment server sends a corresponding account number and a password stored in the database to the 4G mobile phone for performing the authentication with the SIP server according to VoIP authentication procedures; If the authentication is confirmed, the 4G mobile phone is standby for communication.

5. The authentication method of VoLTE according to claim 4, wherein if no any IMSI stored in the database meets the IMSI of the SIM card, then the account assignment server sends an instruction to the 4G mobile phone to report that no such user, registration cannot be achieved.

6. The authentication method of VoLTE according to claim 4, wherein if an IMSI in the database meets the IMSI of the SIM card, but the corresponding IMEI or “security registration sequence number” stored in the database does not meet the IMEI or the “security registration sequence number” of the 4G mobile phone, then the account assignment server sends an instruction to the 4G mobile phone to lock the 4G mobile phone, and the 4G mobile phone is prohibited from registration to avoid pirating.

7. The authentication method of VoLTE according to claim 1, wherein after the 4G mobile phone is turned off, the stored account number and password in the 4G mobile phone disappear;
while the “security registration sequence number” is stored in the 4G mobile phone and the database.
